(19) United States
(12) Patent Application Publication
(10) Pub. No.: US 2014/0012720 A1
(43) Pub. Date: Jan. 9, 2014

(54) INTEGRATED PROPERTY MORTGAGE AND PROPERTY IMPROVEMENT LOAN APPLICATION SYSTEM AND METHOD

(71) Applicant: William H. O'Kane, Lake Bluff, IL (US)

(72) Inventor: William H. O'Kane, Lake Bluff, IL (US)

(21) Appl. No.: 13/541,613

(22) Filed: Jul. 3, 2012

(51) Int. Cl. G06Q 40/02

(52) U.S. Cl. 705/35

(57) ABSTRACT

An integrated property mortgage and property improvement loan system, and method, includes a provision for basing a property mortgage appraisal on a projected increased property value attributable to a selection of planned property improvements.

### TECHNICAL FIELD

The invention generally relates to mortgage application systems and more specifically to property mortgage application systems that incorporate an increased property appraisal value due to a selection of planned property improvements into the property mortgage application.

### BACKGROUND

Home buyers almost always need to secure a mortgage from a bank to pay for a new home. Typically, banks will not lend 100% of the home's value (i.e., the appraised value). Rather, to reduce risk somewhat, banks typically lend less than 100% of a home's value, often 70%-90% of the home's value. As a result, the home buyer must make up the difference between the mortgage and the home value (or purchase price) with cash or a second mortgage.

Often, when buying an older home, the home needs updating or improvements. Because the mortgage is based upon the unimproved appraised value, the home buyer must also come up with funds to finance the updating or improvements.

Between the bank lending the less than 100% of the unimproved home value and the potential for a home needing updating or improvements, most home buyers have difficulty raising the required funds. As a result, many potential home buyers ultimately do not purchase a home because the cash requirements are too great.

This need for a home buyer to bring a significant amount of cash to the table also impacts home sellers, especially home sellers having homes that need updating or improvements. Such sellers are faced with a decision to update or improve the home before listing the home for sale, which requires the sellers to raise funds and to bear the risk that the updates or improvements will not be done to a potential buyer's liking, or to lower the list price of the home to the point where a potential buyer can afford to fund the updates/improvements.

### SUMMARY

In one embodiment, a property mortgage application system includes a server having a processor, a network interface for sending and receiving data via a network, and a computer storage media coupled to the processor that stores computer executable instructions. A plurality of computing devices is coupled to the server via the network. The computer executable instructions, when executed by the processor, cause the server to receive data from one or more of the plurality of computing devices. The data corresponds at least to an estimated increase in property value due to a selection of planned property improvements. The computer executable instructions also to cause the server to create an appraisal of the property value that accounts for the increase in property value due to the selection of planned property improvements.

In another embodiment, a computer readable storage media stores computer executable instructions for creating an appraisal of a property value that, when executed by one or more processors, causes the one or more processors to receive a first appraisal of a property value that is input into the processor, to receive an estimate of an increase in property value due to a selection of planned property improvements, and to create a second appraisal of a property value that accounts for the estimate of the increase in property value due to the selection of planned property improvements.

In yet another embodiment, a method of applying for a property mortgage includes receiving, at a server, information related to a first appraisal of a property value, and to an estimate of an increase of property value resulting from a selection of planned property improvements, and creating a second appraisal of the property value that accounts for the estimate of increased home value resulting from the selection of planned property improvements.

### BRIEF DESCRIPTION OF THE DRAWINGS

Further features and advantages of the invention can be gathered from the claims, the following description, and the attached diagrammatic drawings, wherein:

FIG. 1 is a logic diagram that may be followed by an integrated home mortgage and home improvement loan system;

FIG. 2 is a schematic diagram of various inputs into the integrated home mortgage and home improvement loan system; and

FIG. 3 is a schematic diagram of one embodiment of an integrated home mortgage and home improvement loan system.

### DETAILED DESCRIPTION

Generally speaking, the disclosed integrated property mortgage and property improvement loan system corrects or adjusts an unimproved property appraisal to account for a selection of planned property improvements. The adjusted property appraisal is used to secure a mortgage having a higher cash value. In one embodiment, the property may be a residential home, apartment, or condominium and the property mortgage may be a home mortgage.

Some property improvements can increase the value of the property more than the cost of the improvement itself. For example, in some locations adding an extra bedroom to a house may increase the value of the house by $40,000 or more, while the actual cost of constructing the extra bedroom may only be around $20,000. The higher cash value of a mortgage obtained from the adjusted property appraisal at least partially offsets the amount of funds needed by a buyer to purchase the property and/or to improve the property. As a result, a potential buyer advantageously needs to raise less funds to purchase and improve the property.

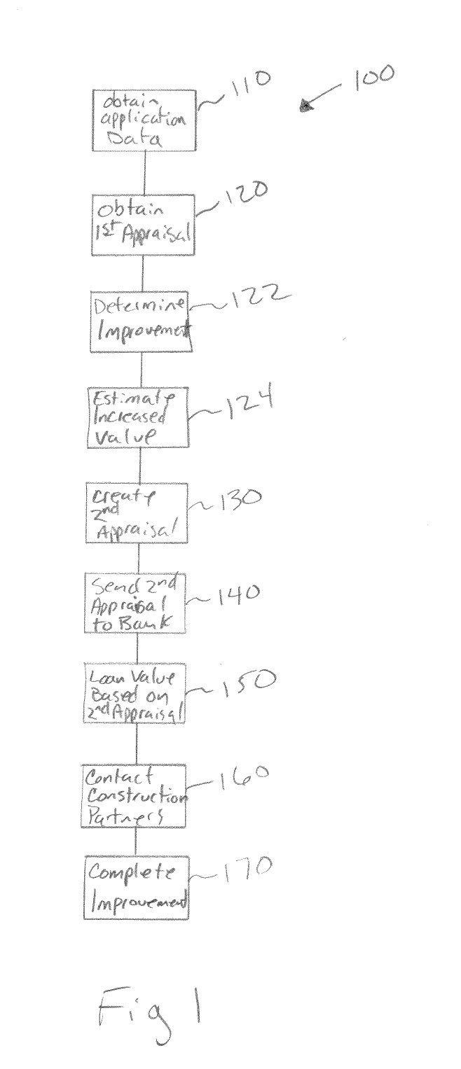

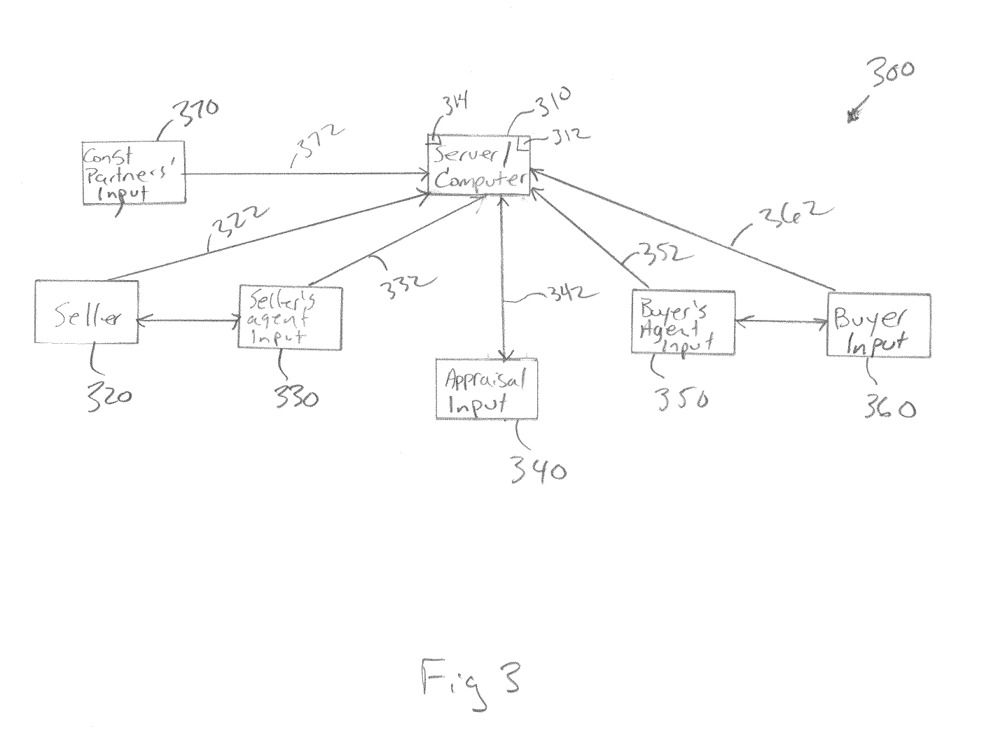

Turning now to FIG. 1, a diagram of logic 100 is illustrated that may be used by one embodiment of the integrated mortgage and property improvement loan system and that may be executed by a processor 312 (FIG. 3). Initially, loan application data is obtained at (block 110) and stored in a memory 314 (FIG. 3) of a computer 310 (FIG. 3). Loan application data may include personal information for the potential buyer, such as job verification, salary, savings, etc. An initial unimproved appraisal of the property is then obtained (block 120). The initial appraisal is based on the unimproved state of the property. Generally speaking, certified appraisers may be used to make the initial appraisal. These appraisers should be trained to be able to accurately assess the market value of the unimproved property.

The potential buyer may determine which updates/improvements will be made to the property (block 122) by making a selection of planned property improvements. For example, the potential buyer may want to renovate a kitchen, a bathroom, or a bedroom. The potential buyer may also decide to add an addition to the property. The potential buyer is free to tailor the selection of planned property improvements to his or her desires. Once the selection of planned property improvements is decided, an estimate is made (block 124) of the increase in property value that the selection of planned property improvements will contribute. Generally speaking, a certified appraiser can make these adjustments. However, appraisers may need specialty training and/or special certification to have the knowledge to accurately determine the increase in property value attributable to selection of planned property improvements.

The potential buyer may repeat the process of making a selection of planned property improvements (block 122) and obtaining an estimate of the increase in property value (block 124) until the potential buyer is satisfied with the level of improvement and increase in property value. This iterative process allows the potential buyer to tailor the selection of planned property improvements to balance the potential buyer's desires with a budget and/or with an increased property value that will be used to secure the mortgage.

Once the value of the selection of planned property improvements has been determined, the appraisal is adjusted to account for the increased value attributable to the selection of planned property improvements and a second improved appraisal is created (block 130). Thereafter, the second appraisal is submitted to the bank (block 140), along with other mortgage application data. The bank uses the second appraisal to determine the mortgage value. For example, if the bank lends at an 80% loan to value (LTV) ratio, and the second appraisal came in at $200,000, the bank may approve a mortgage value of $160,000.

A plurality of factors may be considered when creating the second appraisal. For example, the location of the property, the selection of planned property improvements, the cost of the selection of planned property improvements, and recent sales of properties comparable to the improved property may be considered. The increase in property value due to the selection of planned property improvements may differ from location to location. An improvement correction factor may be determined that accounts for all significant factors that affect the increase in property value due to the selection of planned property improvements. This improvement correction factor, when multiplied by the cost of the selection of planned property improvements, determines an increase in property value. The processor 314 (FIG. 3) may apply the following mathematical formulas to calculate the second appraisal:

Increase in property value=improvement correction factor*cost of selection of planned property improvements (formula 1)

Second appraisal=first appraisal+increase in property value. (formula 2)

Once the bank approves a mortgage value, construction partners are contacted (block 160) to begin planning of the selection of planned property improvements. The construction partners are involved in the process and may have input into the initial planning of the selection of planned property improvements (block 122) to make sure that the cost of the selection of planned property improvements is known in relation to the projected increase in property value. In some embodiments, the construction partners may include one or more of Home Depot®, Lowes®, Menards®, Sears®, other retail home improvement stores, local construction companies, and independent contractors.

The selection of planned property improvements is completed (block 170) either shortly before or shortly after closing of the home sale transaction. As a result, the property buyer is able to move into a completely improved/updated property without having to live in the property while the work is completed.

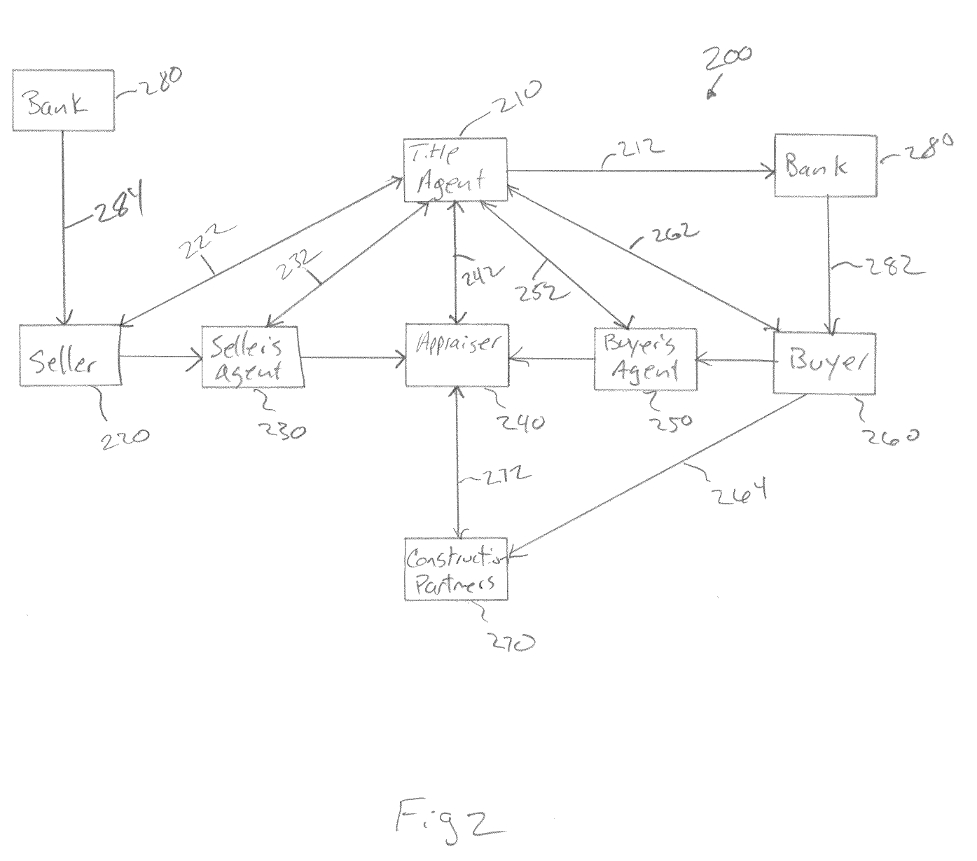

Turning now to FIG. 2, various inputs and their interrelationships of some embodiments of a property mortgage and property improvement loan system are illustrated. A title agent 210 is the focal point for the process. In some embodiments, the title agent 210 may take the form of an internet website for purpose of gathering relevant information. The website (which will be discussed further with respect to FIG. 3) may be accessed via the internet from a remote computer, personal computing device, cell phone, or any other device capable of accessing the internet. Alternatively, the title agent 210 may communicate directly with other devices via a wired or wireless connection as opposed to communicating over the internet. In other embodiments, the title agent 210 may be located on a stand-alone computer, or other device. The title agent 210 takes input from a seller 220, a seller's agent 230, an appraiser 240, a buyer's agent 250, and a buyer 260, each of which may take the form of a stand-alone computer, or as an input/output device that is communicatively connected to the title agent 210 computer or website.

The seller 220 and/or seller's agent 230 may register the property to be sold with the title agent 210 via communication links 222, 232, respectively. The communication links 222, 232 may be wired or wireless communication connections, or the communication links 222, 232, may be web based internet connections. The seller 220 and/or the seller's agent 230 may send information about the property to the title agent 210. The property information may include a physical description of the property, such as the number of bedrooms, the number of bathrooms, the square footage, etc., a legal description of the property, an address of the property, as well as photos or other illustrations. The title agent 210 then registers the property as being for sale and advertises the property through various known channels, such as a multi-listing system (MLS), newspaper adds, websites, etc. Alternatively, the title agent 210 may simply collect data and the seller's agent 230 may advertise the property.

The buyer's agent 250 and/or the buyer 260 also communicate with the title agent 210 over communication links 252, 262, respectively. The communication links 252, 262, may be wired or wireless communication connections, or the communication links 252, 262 may be web based internet connections. The buyer's agent 250 and/or the buyer 260 may send information to the title agent 210 regarding an interest in participating in the integrated property mortgage and property improvement loan system. Additionally, the buyer's agent 250 and/or the buyer 260 may identify a particular property to the title agent 210 to determine whether the particular property is registered with the title agent 210 for the integrated property mortgage and property improvement loan program. If the property is not registered with the title agent 210, the buyer's agent 250 and/or the buyer 260 may send relevant property information to the title agent 210 so that the title agent 210 may contact the seller 220 and/or the seller's agent 230 to determine if the seller 220 would be interested in participating in the program.

Once a property is registered with the title agent 210 and the buyer 260 and the seller 220 settle on a sales price, the title agent 210 communicates with the buyer 260 over the communication link 262 (which may be the same communication link previously used or a completely new communication link) to determine desired upgrades and/or improvements for the property. Once the buyer 260 makes a selection of planned property improvements, the title agent 210 contacts an appraiser 240 through communication link 242 and the appraiser determines the potential increase in property value attributable to the selection of planned property improvements. Once the increase in property value is determined, the appraiser 240 sends the increased value to the title agent 210. In some embodiments, the appraiser 240 may be integrated into the title agent 210 so that the increase in property value may be calculated by the title agent 210 computer, as described above with reference to FIG. 1. In other embodiments, the buyer 260, the title agent 210, and the appraiser 240 may iteratively select desired upgrades or improvements and determine the increase in property value until the buyer 260 is satisfied with both the planned upgrades/improvements and the potential increase in property value due to the planned upgrades/improvements.

The buyer 260 may contact a construction partner 270 through communication line 264 to arrange details of the updates/improvements to the property, such as scheduling, color selection, material selection, etc. The construction partner 270 communicates with the appraiser 240 over communication link 272 to coordinate pricing of the selection of planned property improvements.

Once the title agent 210 has the increased property value from the appraiser 240, the title agent 210 creates a second, improved appraisal and sends the second appraisal, along with other loan application information, to a bank 280 over communication link 212. Although only one bank 280 is illustrated, the title agent 210 may send the information to more than one bank 280 if the buyer 260 is working with more than one bank 280. The bank 280 then approves a mortgage value based upon the second appraisal and sends the buyer 260 a notice via communication link 282 that the buyer 260 has been approved for the mortgage. The bank 280 may also send the funds to the seller 220 at closing via communication link 284.

Turning now to FIG. 3, a schematic representation of one embodiment of the integrated property mortgage and property improvement loan system is illustrated. As discussed above with respect to FIG. 2, the title agent 210 may take the form of a computer or server 310 having one or more communication links in the form of network interfaces 322, 332, 342, 352, 362, 372. In the embodiment of FIG. 3, the server 310 is accessed at least partially via the internet through the one or more network interfaces 322, 332, 342, 352, 362, 372. The server 310 may include a processor 312 and a storage media or memory 314. The memory 314 may include one or more software programs that are executable on the processor 312. The software may include instructions for maintaining a website that is accessible through the internet. In other embodiments, the software may include instructions that are executable on the processor to take all inputs and to make all calculations on a single computer.

The software stored in the memory 314, when executed by the processor 312, causes the server 310 to receive input from a variety of input devices, such as a seller input device 320, a seller's agent input device 330, an appraisal input device 340, a buyer's agent input device 350, a buyer input device 360, and a construction partner input device 370. The input devices may be computing devices having a processor and a memory that are connected to the internet, or computing devices having a processor and a memory that connected directly (via wired or wireless connections) to the server 310. Non-limiting examples of the input devices include personal computers, other servers, mobile computing devices, and cell phones. Property information may be input into the seller input device 320 and/or the seller's agent input device 330 and communicated to the server 310 via network interfaces 322 and 332, respectively. Similarly, buyer information may be input into the buyer's agent input device 350 and/or the buyer input device 360 and communicated to the server 310 via network interfaces 352 and 362, respectively.

Once the property information has been sent to the server 310, the server may communicate with the appraisal input device 340 via network interface 342, for example. The first unimproved appraisal of the property value may be communicated to the server 310 via network interface 342. The buyer's agent and/or the buyer may send a selection of planned property improvements to the server 310 via the network connections 352, 362. The server 310 may then communicate with the construction partner's input 370 via network interface 372 to receive an estimate of costs for the selection of planned property improvements. The selection of planned property improvements are also sent to the appraisal input device 340 via network interface 342. An estimate of an increase in home value due to the selection of planned property improvements is sent from the appraisal input device 340 to the server 310 through network interface 342. In some embodiments, the appraisal input device 340 may be integral with the server 310 so that the estimate of the increase in home value due to the desired improvements is calculated by software stored in the memory 314 and executed by the processor 312 of the server 310. Once the server 310 receives the estimate of the increase in home value due to the selection of planned property improvements, software executed by the processor creates a second improved appraisal that accounts for the increase in home value due to the selection of planned property improvements.

In some embodiments, construction partners may input a plurality of standard or prepackaged property improvement plans into the construction partners input device 370, which are then sent to the server 310 to be stored in the memory 314. The buyer may communicate with the server 310 through the buyer input device 360 such that the buyer is able to view the standard improvement packages and select one or more of the standard improvement packages. An increase in property value for each of the standard packages may be input into the server 310 so that the server 310 is capable of calculating an increase in property value without further input from the appraisal input device 340 when the buyer selects a standard improvement package. For example, the construction partners may provide a plurality of property improvement packages representing various levels of property improvement. For example, a construction partner may provide a “luxury” improvement package, a “standard” improvement package, and a “economy” improvement package, for example. Each package may have a predetermined improvement correction factor and a total package cost associated therewith. For example, the “luxury” package may include an improvement correction factor of 0.8 and a total cost of $50,000. Thus, the “luxury” package would add a total of $40,000 to the value of the improved property for the purposes of obtaining a mortgage. The “standard” package may include an improvement correction factor of 1.0 and a total cost of $30,000. Thus, the “standard” package would add a total of $30,000 to the value of the improved property for the purposes of obtaining a mortgage. Similarly, the “economy” package may include an improvement correction factor of 1.1 and a total cost of $10,000 (as the “economy” package may be focused on obtaining the greatest increase in improved property value for the least cost). Thus, the “economy” package would add a total of $11,000 to the value of the improved property for the purposes of obtaining a mortgage.

After the server 310 creates the second appraisal, the second appraisal is communicated to the bank 280 (FIG. 2) for the bank to determine the amount of the mortgage for the property.

In this way, the integrated property mortgage and property improvement loan system produces an appraisal that accounts for a selection of planned property improvements so that costs for the selection of planned property improvements may be at least partially included in the property mortgage. As a result, the buyer advantageously has a reduced cash requirement, or may even receive cash back at closing for the property improvements.

Several examples of results from the integrated property mortgage and property improvement loan system are described below. The examples are for illustration purposes only and are not limiting in any way.

### Example #1

Bank mortgage LTV ratio: 90%

Property purchase price: $160,000

Property improvement costs: $20,000; $30,000; $40,000; or $50,000

Each of the improvements increases the value of the home by $40,000. Traditional costs for the purchase of this theoretical property are summarized below in Table 1.

TABLE 1

| | First mortgage | | | |
|---|---|---|---|---|
| | (90% of the first | | | |
| | unimproved | | | |
| Purchase | appraisal price | Cash due | Improvement | Total Buyer |
| price | of $160,000) | from Buyer | cost | outlay |
| $160,000 | $144,000 | $16,000 | $20,000 | $36,000 |
| $160,000 | $144,000 | $16,000 | $30,000 | $46,000 |
| $160,000 | $144,000 | $16,000 | $40,000 | $56,000 |
| $160,000 | $144,000 | $16,000 | $50,000 | $66,000 |

Costs associated with the disclosed integrated property mortgage and property improvement loan system are summarized in Table 2 below:

TABLE 2

| | First mortgage | | | |
|---|---|---|---|---|
| | (90% of second | | | |
| | improved | Cash due | | |
| Purchase | appraisal price | from Buyer | Improvement | Total Buyer |
| price | of $200,000) | for closing | cost | cash outlay |
| $160,000 | $180,000 | $−20,000 | $20,000 | $0 |
| $160,000 | $180,000 | $−20,000 | $30,000 | $10,000 |
| $160,000 | $180,000 | $−20,000 | $40,000 | $20,000 |
| $160,000 | $180,000 | $−20,000 | $50,000 | $30,000 |

When comparing the two tables above, the integrated property mortgage and property improvement loan system saves the buyer approximately $20,000 in cash outlay. This savings is due to the fact that a portion of the projected increased value of the property is incorporated into the mortgage. Thus, the bank will loan the buyer more money based on the revised mortgage.

The disclosure is not limited to internet based integrated property and property improvement loan systems. The disclosure could be applied to virtually any computer based system of creating a property appraisal that accounts for a selection of planned property improvements. The features of the invention disclosed in the description, drawings and claims can be individually or in various combinations for the implementation of the different embodiments of the invention.

1. A property mortgage application system comprising:
a server having a processor, a network interface for sending and receiving data via a network, and a computer storage media coupled to the processor that stores computer executable instructions; and
a plurality of computing devices coupled to the server via the network,
wherein the computer executable instructions, when executed by the processor, cause the server to
receive data from one or more of the plurality of computing devices, the data corresponding at least to
i) a first appraisal value of a property,
ii) a selection of planned property improvements,
iii) a total cost for the selection of planned property improvements, and
iv) an improvement correction factor corresponding to the selection of planned property improvements,
calculate an increase in property value based on the total cost for the selection of planned property improvements and the improvement correction factor,
create a second appraisal of the property value that accounts for the increase in property value due to the selection of planned home improvements by adding the calculated increase in property value to the first appraisal value of the property, and
transmit the second appraisal of the property value to one or more computing devices for use in a property mortgage loan application.

2. The property mortgage application system of claim 1, wherein the server is communicatively connected to the internet.

3. The property mortgage application system of claim 1, wherein one computing device in the plurality of computing devices is an appraisal input device for inputting the improvement correction factor.

4. The property mortgage application system of claim 1, wherein one of the computing devices in the plurality of computing devices is a construction partner input device for inputting a cost estimate of the selection of planned property improvements.

5. The property mortgage application system of claim 4, wherein the construction partner input device transmits at least one standard improvement package to the server, the at least one standard improvement package including a selection of planned property improvements, a total cost of the selection of planned property improvements, and the improvement correction factor associated with the at least one standard improvement package.

6. The property mortgage application system of claim 1, wherein the increase in property value due to the selection of planned property improvements is greater than a cost of the selection of planned property improvements.

7. The property mortgage application system of claim 1, wherein a bank bases a mortgage value for the property on the second appraisal that accounts for the increase in property value attributable to the selection of planned property improvements.

8. The property mortgage application system of claim 1, wherein one computing device in the plurality of computing devices is a buyer input device for inputting buyer loan data.

9. The property mortgage application system of claim 8, wherein the buyer input device transmits a selection of planned property improvements to the server.

10. A computer readable storage media storing computer executable instructions for creating an appraisal of a property value that when executed by one or more processors cause the one or more processors to:
receive data from one or more of the plurality of computing devices, the data corresponding at least to
i) a first appraisal value of a property,
ii) a selection of planned property improvements,
iii) a total cost for the selection of planned property improvements, and
iv) an improvement correction factor corresponding to the selection of planned property improvements,
calculate an increase in property value based on the total costs for the selection of planned property improvements and the improvement correction factor,
create a second appraisal of the property value that accounts for the increase in property value due to the selection of planned property improvements by adding the calculated increase in property value to the first appraisal value of the property, and
transmit the second appraisal of the property value to one or more computing devices for use in a property mortgage loan application.

11. The computer readable storage media of claim 10, wherein the computer executable instructions, when executed by the one or more processors, cause the one or more processors to receive loan data from a buyer input device.

12. The computer readable storage media of claim 11, wherein the computer executable instructions, when executed by the one or more processors, cause the one or more processors to receive the selection of planned property improvements from the buyer input device.

13. The computer readable storage media of claim 10, wherein the computer executable instructions, when executed by the one or more processors, cause the one or more processors to receive an estimate of costs for the selection of planned property improvements from a construction partner input device.

14. The computer readable storage media of claim 13, wherein the computer executable instructions, when executed by the one or more processors, cause the one or more processors to receive a standard package of property improvements from the construction partner input device, the standard package of property improvements including a total cost for the standard package of property improvements and an improvement correction factor associated with the standard package of property improvements.

15. The computer readable storage media of claim 10, wherein the computer executable instructions, when executed by the one or more processors, cause the one or more processors to receive an estimate of increased property value from an appraisal input device, the estimate reflecting an increase in property value based on the selection of planned property improvements.

16. A method of applying for a property mortgage using a computing device, the method comprising:
receiving, at a server, information related to:
i) a first appraisal of a property value;
ii) a selection of planned property improvements;
iii) a total cost for the selection of planned property improvements; and
iv) an improvement correction factor corresponding to the selection of planned property improvements;
calculating an increase in property value that accounts for the selection of planned property improvements by multiplying the improvement selection factor by the total costs for the selection of planned property improvements; and
creating a second appraisal of the property value that accounts for the estimate of increased property value as a result of the selection of planned property improvements by adding the increase in property value to the first appraisal of property value.

17. The method of claim 16, further comprising sending the second appraisal to a bank input device for consideration in a property mortgage application.

18. The method of claim 16, wherein the improvement correction factor corresponding to the selection of planned property improvements is received from an appraisal input device.

19. The method of claim 16, wherein the sever receives loan information from a buyer input device.

20. The method of claim 19, wherein the server receives the selection of planned property improvements from the buyer input device.
